(19) United States
(12) Patent Application Publication
(10) Pub. No.: US 2010/0029328 A1
(43) Pub. Date: Feb. 4, 2010

(54) HANDHELD DEVICE AND POWER SAVING METHOD THEREOF

(76) Inventors: Yung-Hsien KUO, Taoyuan County (TW); Chi-Feng LEE, Taoyuan County (TW); Tai-Chuan CHEN, Taoyuan County (TW)

Correspondence Address: BIRCH STEWART KOLASCH & BIRCH, PO BOX 747, FALLS CHURCH, VA, 22040-0747, US

(21) Appl. No.: 12/463,055

(22) Filed: May 8, 2009

(30) Foreign Application Priority Data
Jul. 31, 2008 (TW) 097129005

(51) Int. Cl. H04M 1/00; H04N 7/18; G09G 5/02

(52) U.S. Cl. 455/556.1; 348/77; 345/589; 455/574

(57) ABSTRACT

A handheld device and power saving method thereof are disclosed. The steps include: actuating an image-catching device; catching an image near the handheld device via the image-catching device; identifying whether the caught image conforms to a built-in ear image within a predetermined time period; and diminishing the brightness of a display when the caught image conforms to the built-in ear image. The handheld device with a display includes a processor electrically connected to an image-catching device. When the processor determines that a communication event has occurred, the processor enables the image-catching device to control the brightness of the display.

### CROSS REFERENCE TO RELATED APPLICATIONS

This Application claims priority of Taiwan Patent Application No. 097129005, filed on Jul. 13, 2008, the entirety of which is incorporated by reference herein.

### BACKGROUND OF THE INVENTION

1. Field of the Invention

The subject application relates to a handheld device and a power saving method thereof, and in particular relates to a power saving method utilizing an image-catching device of the handheld device for controlling the brightness of a display.

2. Description of the Related Art

FIG. 1 is a flow chart showing the steps of a power saving method for a conventional handheld device. Referring to FIG. 1, the conventional handheld device comprises a display and a display power source button. When the handheld device receives an incoming call, the display shows an incoming call notice. Users press a pick-up key to answer the incoming call. Usually, to decrease power consumption during communications, users press the display power source button to turn off the display power source for power saving after pressing the pick-up key. However, simultaneously answering the incoming call and pressing the display power source button is inconvenient for users.

Another conventional handheld device further comprises an infrared ray receiving/transmitting element and a sensor, for example, a light sensor. The conventional handheld device sends a signal from the infrared ray receiving/transmitting element to be reflected for measuring the distance between users and the handheld device. The handheld device determines whether the display is turned off or not via the distance for power saving. Similarly, the user would be close to the handheld device when he or she pick-up the incoming call, the handheld device will determine whether the display is turned of or not via the light detected by the light sensor. However, adding the infrared ray receiving/transmitting element or sensor would increase costs of the conventional handheld device. In addition, costs associated with rearranging the inner other elements of the handheld device due to the infrared ray receiving/transmitting element or sensor also increases total costs of the conventional handheld device.

### BRIEF SUMMARY OF THE INVENTION

The subject application provides a power saving method for a handheld device. When a phone call occurs, the power saving method steps comprise: actuating an image-catching device; catching an image near the handheld device via the image-catching device; identifying whether the caught image conforms to a built-in ear image within a predetermined time period; and diminishing the brightness of a display when the caught image conforms to the built-in ear image.

Note that the steps further comprise: if unable to identify whether the caught image conforms to the built-in ear image within the predetermined time period, diminishing the brightness of a display after the predetermined time period.

Note that the phone call comprises receiving an incoming call or dialing a call by the handheld device.

Note that the phone call comprises actuating an image-catching device by touching an input element of the handheld device.

Note that the input element comprises a physical key or a virtual key.

The subject application provides a handheld device having a display. The handheld device comprises a processor electrically connected to an image-catching device. When the processor determines that a phone call has occurred, the processor actuates an image-catching device for controlling the brightness of the display. Note that the handheld device further comprises a storage unit for storing a built-in ear image in advance.

Note that the image-catching device catches an image near the handheld device, and the processor identifies whether the caught image conforms to the built-in ear image within a predetermined time period.

Note that when the caught image conforms to the built-in ear image, the processor diminishes the brightness of the display.

Note that if unable to identify whether the caught image conforms to the built-in ear image within the predetermined time period, the brightness of the display is diminished after the predetermined time period.

Note that the phone call comprises receiving an incoming call or dialing a call by the handheld device.

Note that the phone call comprises actuating an image-catching device by touching an input element of the handheld device.

Note that the input element comprises a physical key or a virtual key.

Note that after the phone call occurs, the handheld device is set in a receiver mode to identify whether the caught image conforms to the built-in ear image and then determines whether the brightness of the display is diminished or not.

The subject application provides another power saving method for a handheld device. When a phone call occurs and the handheld device is in a receiver mode, the power saving method steps comprise: actuating an image-catching device; catching an image near to the handheld device via the image-catching device; identifying whether the caught image conforms to the built-in ear image within a predetermined time period; and diminishing the brightness of a display when the caught image conforms to the built-in ear image. Meanwhile, when the handheld device is set in a hand-free receiver mode, the brightness of a display is controlled according to the setting of the hand-free receiver mode.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a flow chart showing the steps of a power saving method for a conventional handheld device;

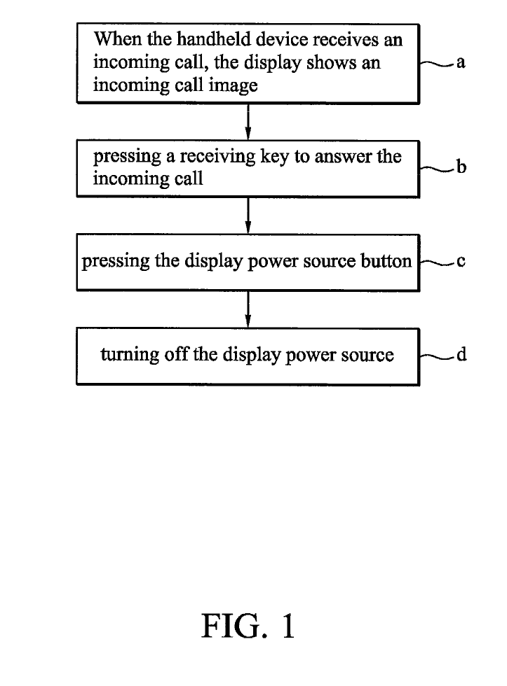

FIG. 2 is a schematic view of a handheld device of the present invention;

FIG. 3 is a flow chart showing the steps of a power saving method for the present invention; and

FIG. 4 is a schematic view of another embodiment of a handheld device of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

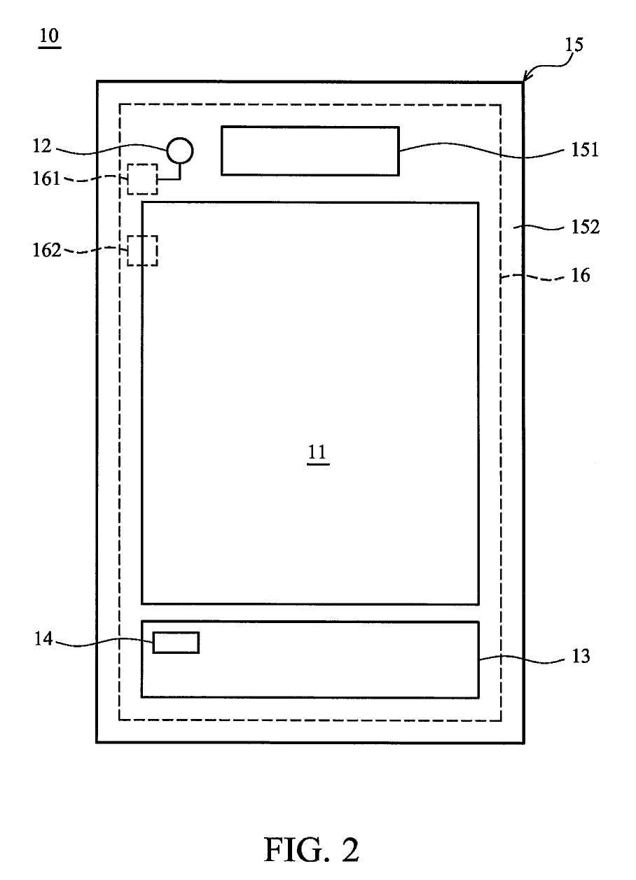

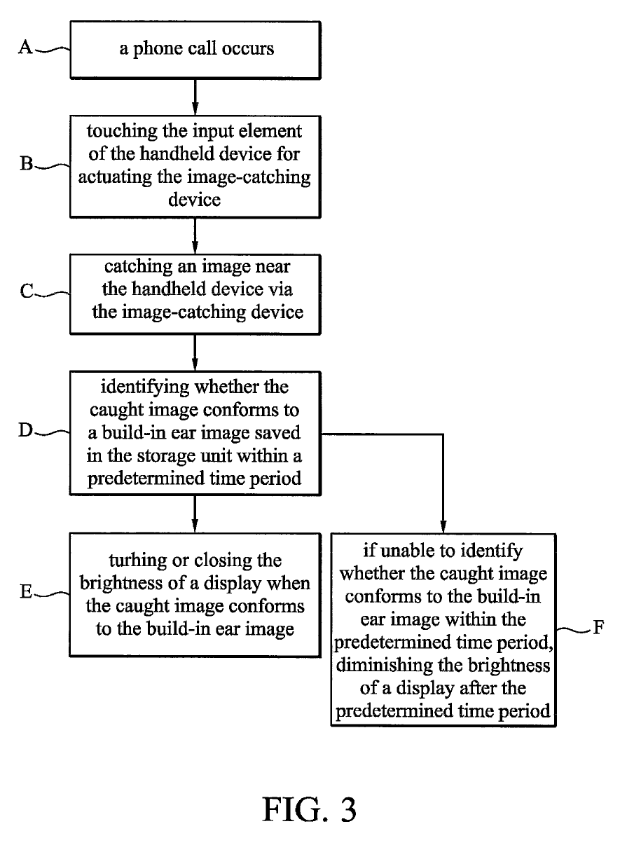

Referring to FIGS. 2 and 3, FIG. 2 is a schematic view of a handheld device of the invention, and FIG. 3 is a flow chart showing the steps of a power saving method for a handheld device of the invention.

The handheld device 10 comprises a display 11, an image-catching device 12, an input element 13, a pick-up key 14, a housing 15 and a circuit board 16. The circuit board 16 comprises a processor 161 and a storage unit 162. The processor 161 is electrically connected to the image-catching device 12. The image-catching device 12 catches an image in advance, and then the storage unit 162 saves the image as a built-in ear image. The built-in ear image is inputted by an external electronic device (for example: a computer, PDA, UMPC or mobile phone), such as the image-catching device 12, but is not limited thereto. The housing 15 mainly comprises a receiver 151, a speaking surface 152, the image-catching device 12, the input element 13 and the display 11. The input element 13 generally comprises a plurality of physical keys. The pick-up key 14 is one of the physical keys. However, the pick-up key 14 is not limited to only belonging to the input element 13. The pick-up key 14 may be installed on any suitable position of the housing 15 (not shown). The image-catching device 12 may be a camera but is not limited. When a phone call, which comprises receiving an incoming call or dialing a call, occurs, the processor 162 determines that the phone call has occurred. Thus, proceeding with the communication function, the processor 162 actuates the image-catching device 12, and then the image-catching device 12 catches an image near the handheld device 10. The caught image is compared with the built-in ear image saved in the storage unit 162. According to comparison result, the brightness of the display 11 is controlled. Users press/touch the pick-up key 14 of the handheld device 10 for receiving the phone call and enabling the image-catching device 12. Controlling the brightness of the display 11 means to turn down the brightness of the display 11 or completely close the display 11 to decrease power consumption and save power. The brightness of the handheld device 10 is controlled by the backlight module. The brightness of the display may be adjusted by the image-catching device 12 for cooperating with other essential elements concurrently.

Note that the image-catching device 12 and the speaking surface 152 must be installed on the same surface of the handheld device 10. When the handheld device 10 moves closer to a user, the image-catching device 12 catches an image near the handheld device 10 and identifies whether the caught image conforms to the built-in ear image.

The steps of the power saving method for the handheld device are disclosed as follow. Referring to FIGS. 2 and 3, when a phone call occurs, the handheld device 10 enters a receiver mode. A user touches the input element 13 of the handheld device 10 for actuating the image-catching device 12. When the handheld device 10 approaches the ear of the user, the image-catching device 12 of the speaking surface 152 catches an image near the handheld device 10. Then, the processor 161 identifies whether the caught image conforms to the built-in ear image saved in the storage unit 162 within a predetermined time period. When the caught image conforms to the built-in ear image, the processor 161 installed on the printed circuit board 16 transmits a signal for turning down or closing the brightness of the display 11. If unable to identify whether the caught image conforms to the built-in ear image within the predetermined time period, the brightness of the display 11 is diminished after the predetermined time period.

Note that if the handheld device 10 is set in the receiver mode, the previous steps are executed. If the handheld device 10 is set in a hand-free receiver mode, the brightness of the display 11 is controlled according to the hand-free receiver mode. In the hand-free receiver mode, the handheld device 10 automatically turns off or closes the brightness of the display 11 within a predetermined time period after the phone call is finished. Controlling the brightness of the display 11 as above achieves the objective of decreasing power consumption of the handheld device 10 and saving power.

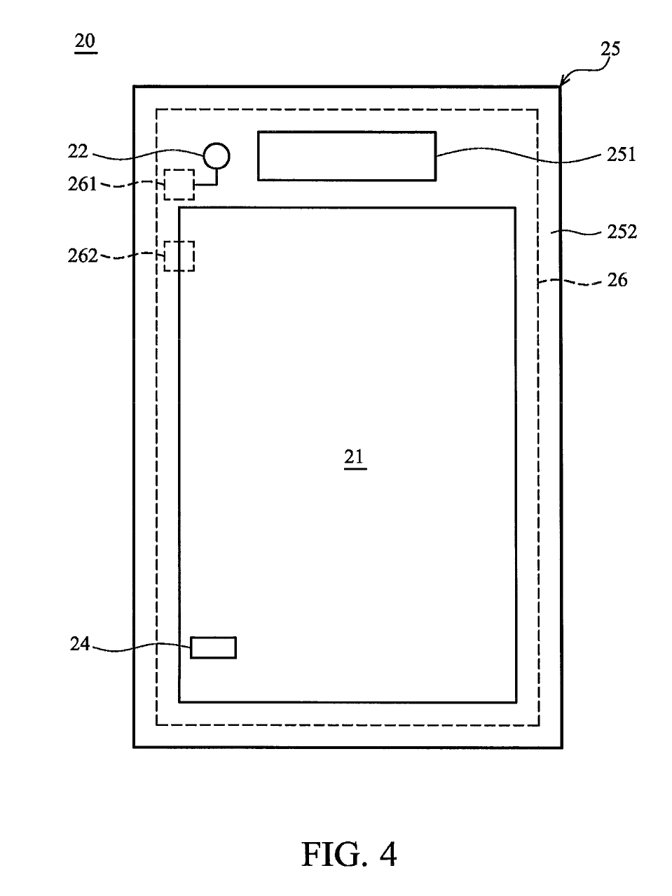

FIG. 4 is a schematic view of another embodiment of the present invention. Referring to FIG. 4, the structure of the handheld device 20 is approximately similar to the handheld device 10 in FIG. 2, and like descriptions are omitted for brevity. The only difference is that the display 21 of the handheld device 20 is a touch panel and the input element 24 is a virtual key displayed on the touch panel.

In summary, when a phone call occurs, the power saving method for the handheld device catches an image via the image-catching device. The processor identifies whether the caught image conforms to the built-in ear image. If the caught image conforms to the built-in ear image, a user conducting a call is confirmed. At this time, turning down or closing the brightness would not affect the operation of the handheld device, but achieves power saving. The power saving method for the handheld device of the present invention utilizes the relationship between the hardware elements as above, and the software design of the power source for controlling the brightness of the display. Thus, the problems previously outlined, inconvenient operation and higher manufacturing costs for the conventional handheld device can be avoided.

While the present invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A power saving method for a handheld device, wherein when a phone call occurs, the steps comprise:
actuating an image-catching device;
catching an image near the handheld device via the image-catching device;
identifying whether the caught image conforms to a built-in ear image within a predetermined time period; and
diminishing the brightness of a display when the caught image conforms to the built-in ear image.

2. The power saving method for a handheld device as claimed in claim 1, further comprising:
if unable to identify whether the caught image conforms to the built-in ear image within the predetermined time period, diminishing the brightness of a display after the predetermined time period.

3. The power saving method for a handheld device as claimed in claim 1, wherein the phone call comprises receiving an incoming call or dialing a call by the handheld device.

4. The power saving method for a handheld device as claimed in claim 1, wherein the phone call comprises actuating an image-catching device by touching an input element of the handheld device.

5. The power saving method for a handheld device as claimed in claim 4, wherein the input element comprises a physical key or a virtual key.

6. A handheld device, having a display, comprising:
a processor, electrically connected to an image-catching device;
wherein when the processor determines that a phone call has occurred, the processor actuates an image-catching device for controlling the brightness of the display.

7. The handheld device as claimed in claim 6, further comprising:
a storage unit, to store a built-in ear image in advance.

8. The handheld device as claimed in claim 7, wherein the image-catching device catches an image near the handheld device, and the processor identifies whether the caught image conforms to the built-in ear image within a predetermined time period.

9. The handheld device as claimed in claim 8, wherein when the caught image conforms to the built-in ear image, the processor diminishes the brightness of the display.

10. The handheld device as claimed in claim 8, wherein if unable to identify whether the caught image conforms to the built-in ear image within the predetermined time period, the brightness of the display is diminished after the predetermined time period.

11. The handheld device as claimed in claim 6, wherein the phone call comprises receiving an incoming call or dialing a call by the handheld device.

12. The handheld device as claimed in claim 6, wherein the phone call comprises actuating the image-catching device by touching an input element of the handheld device.

13. The handheld device as claimed in claim 12, wherein the input element comprises a physical key or a virtual key.

14. The handheld device as claimed in claim 11, wherein when after the phone call occurs, the handheld device is set in a receiver mode to identify whether the caught image conforms to the built-in ear image and then determines whether the brightness of the display is diminished or not.

15. A power saving method for a handheld device, wherein when a phone call occurs, the steps comprise:
when the handheld device is set in a receiver mode, executing the steps as claimed in claim 1; and
when the handheld device is set in a hand-free receiver mode, controlling the brightness of a display according to the setting of the hand-free receiver mode.
